(19) United States
(12) Patent Application Publication
(10) Pub. No.: US 2026/0341822 A1
(43) Pub. Date: Oct. 29, 2026

(54) Method for reconditioning lithium-containing energy accumulators

(71) Applicant: CYLIB GmbH, Aachen (DE)

(72) Inventors: Lilian Schwich, Aachen (DE); Paul Sabarny, Aachen (DE)

(21) Appl. No.: 19/107,845

(22) PCT Filed: Aug. 25, 2023
(86) PCT No.: PCT/EP2023/073322

§ 371 Date: Feb. 28, 2025

(30) Foreign Application Priority Data
Aug. 30, 2022 (DE) 10 2022 121 918.6

(51) Int. Cl. H01M 10/54; B09B 3/40; B09B 3/80; B09B 101/16; H01M 10/44

(52) U.S. Cl. CPC H01M 10/54; B09B 3/40; B09B 3/80; H01M 10/44; B09B 2101/16

(57) ABSTRACT

The present invention relates to a method for reprocessing lithium-containing energy storage means, the method comprising at least the following method steps:
i) —optionally pretreating the lithium-containing energy storage means, the pretreatment comprising at least one of thermal, mechanical, and electrical pretreatment;
ii) pyrolysing the optionally pretreated lithium-containing energy storage means, with the liberation of carbon dioxide, and with at least partial carbonation of the contained lithium under a carbon dioxide atmosphere;
iii) separating lithium in a separating step; and
iv) hydrometallurgically reprocessing the mixture obtained in method step iii), with further carbonation of the contained lithium and with separation of lithium in a further separating step, with
v) carbon dioxide liberated in method step ii) being returned to at least one of method steps ii) and iii).

### CROSS-REFERENCE TO RELATED APPLICATIONS

This is a U.S. National Phase of International Application PCT/EP2023/073322, filed Aug. 25, 2023, which claims priority to German Patent Application No. 10 2022 121 918.6, filed Aug. 30, 2022.

### FIELD OF THE DISCLOSURE

The present invention relates to a method for reprocessing lithium-containing energy storage means. The present invention relates in particular to a method by which lithium-containing energy storage means, in particular lithium-ion batteries, can be reprocessed or recycled.

### BACKGROUND

Sustainable and resource-efficient operation is becoming ever more important in every field of technology. Increasing levels of electromobility mean that the recycling of lithium-ion batteries is attracting greater interest and gaining in relevance, battery recycling rates having an impact on the life cycle assessment of electric vehicles. Moreover, the EU Battery Directive requires recycling efficiency of 50 wt. %. This legislative basis will in future become more stringent with regard to recycling efficiency. Elemental recovery rates are also being introduced. Until now, economic interests have meant that established recycling methods have focused on recovering cobalt and nickel. For example, cobalt, nickel and manganese constitute up to 80% of material values from recycling NMC cells (lithium nickel manganese cobalt oxides). For cost reasons, however, it is expected that cobalt will be largely dispensed with in future battery systems (lithium iron phosphate (LFP) system) or that its use will at least be minimised (nickel cobalt aluminium (NCA) system). Lithium, on the other hand, will probably continue to be an established component of lithium-ion batteries due to its properties such as low density and lowest standard potential. Efficient lithium recycling is thus a necessity. Economic and geopolitical factors are further driving forces behind lithium recycling.

WO 2021/226719 A1 describes a hydrometallurgical green chemistry method for recovering one or more metals from a metal-containing material comprising leaching the metal-containing material with formic acid, obtaining a leachate containing the one or more metals as one or more metal formates, and precipitating at least one of the one or more metal formates. The metal-containing material may be a cathode material for lithium-ion batteries, which results in Li formate remaining in solution and salts containing one or more Ni, Co and Mn formates being precipitated out. Steps may include filtering the leachate, sulfurising the retained metal formate salts to produce metal sulfate salts, purifying the filtered leachate by addition of lithium carbonate and filtration, dewatering the purified leachate, and thermally decomposing the lithium salts obtained to produce battery grade lithium carbonate.

CN109921125 A describes a pretreatment method for recycling lithium batteries comprising the following steps: step 1, disassembling a lithium battery to obtain a positive plate, a negative plate, a separator, a battery shell and a cover plate; step 2, performing preliminary grinding on the positive plate and selecting a positive electrode material and a conductive agent; step 3, performing heat treatment on the positive electrode material; step 4, mixing the heat-treated positive electrode material with an active additive for mechanical grounding to activate the positive electrode material; and step 5, performing preliminary grinding on the negative plate and then placing in a shaker for separation to select a metal foil material and a preparation.

CN106505271 A discloses a method for recycling a lithium-ion battery. The method comprises the steps of cutting electrode plates removed from the lithium-ion battery into pieces and carrying out stepwise heating and heat preservation in a heating furnace with a gas collection device; stirring the electrode plates subjected to heating and heat preservation into a sodium hydroxide solution until an electrode material is stripped from the aluminium foil; directly recycling the aluminium foil, simultaneously collecting the electrode material, washing and drying the electrode material and then grinding the electrode material evenly in a ball mill; and testing the content of various elements in the electrode material.

CN113921931 A relates to a method for recycling lithium carbonate from retired lithium-ion batteries, in particular to a method for recycling lithium carbonate from retired lithium-ion batteries through thermal reduction using carbon. This document aims to solve the technical problems that positive and negative electrode materials in the existing retired lithium-ion battery black powder are difficult to separate and lithium resources are difficult to recycle. According to the method, a decommissioned lithium-ion battery can be directly broken up and screened to obtain the black powder under the conditions of no discharge and no disassembly and separation, lithium is recycled from the decommissioned lithium-ion battery to the greatest extent, while nickel, cobalt and manganese in the filter residues obtained through first suction filtration in the first step are used for preparing a precursor or are purposefully recycled.

### SUMMARY

The solutions known from the prior art may, however, still have potential for improvement, particularly with regard to efficiently recycling lithium-containing batteries.

The object of the present invention is therefore to create a measure that at least partially overcomes at least one disadvantage of the prior art. In particular, it is an object of the present invention to provide a solution by way of which the recycling of lithium-containing batteries can be improved.

The object is achieved according to the invention by a method having the features of claim 1 and claim 2. The object is furthermore achieved by the use of the method according to the invention for recovering lithium and anode material from lithium-containing energy storage means. Preferred developments of the invention are disclosed in the subclaims, in the description and in the figures, with further features described or shown in the subclaims or in the description or the figures possibly individually or in any desired combination constituting subject matter of the invention unless the context clearly indicates otherwise.

The present invention relates to a method for reprocessing lithium-containing energy storage means, the method comprising at least the following method steps:
i) —optionally pretreating the lithium-containing energy storage means, the pretreatment comprising at least one of thermal, mechanical, and electrical pretreatment;
ii) pyrolysing the optionally pretreated lithium-containing energy storage means, with the liberation of carbon dioxide, and with at least partial carbonation of the contained lithium under a carbon dioxide atmosphere;
iii) separating lithium in a separating step; and
iv) hydrometallurgically reprocessing the mixture obtained in method step iii), with further carbonation of the contained lithium and with separation of lithium in a further separating step, with
v) carbon dioxide liberated in method step ii) being returned to at least one of method steps ii) and iii).

The present invention relates to a method for reprocessing lithium-containing energy storage means, the method comprising at least the following method steps:
i) —optionally pretreating the lithium-containing energy storage means, the pretreatment comprising at least one of thermal, mechanical, and electrical pretreatment;
ii) pyrolysing the optionally pretreated lithium-containing energy storage means, with the liberation of carbon dioxide, and with at least partial carbonation of the contained lithium under a carbon dioxide atmosphere;
iii) separating lithium in a separating step; and
iv) hydrometallurgically reprocessing the mixture obtained in method step iii), with further carbonation of the contained lithium and with separation of lithium in a further separating step.

The above-described method thus serves to reprocess lithium-containing energy storage means. Reprocessing should in particular be taken to mean a process that enables recovery of the raw materials contained in the energy storage means. For example, an energy storage means usually includes metals or metal compounds that can be used as raw materials for value creation. In particular, the lithium used in energy storage means can be recovered using the method described here, the method not, however, being limited to obtaining lithium, as a person skilled in the art will understand. For example, anode material such as graphite can also be recovered.

Accordingly, the choice of reprocessed lithium-containing energy storage means is not restricted, it also in particular being possible to use lithium storage batteries or lithium-ion storage batteries. Against a backdrop of expanding electromobility, recycling used lithium-ion batteries is increasingly coming to the fore. Accordingly, the method described here in particular uses lithium-containing energy storage means which have reached the end of their useful life. Such energy storage means are known as “end of life” energy storage means. However, it is in principle also possible to use other energy storage means, such as faultily manufactured or damaged energy storage means. The advantage of using secondary material as the starting material for the method described here is in particular that lithium is more concentrated in energy storage means than in primary ores, for example. In comparison with mining, extraction is therefore in principle simplified and therefore advantageous. At the same time, lithium is currently not sufficiently recycled, which is why the invention contributes to the closed-loop management of battery raw materials. According to the invention, shredded material, production scrap, cells, modules and mixtures thereof can be used as the lithium-containing energy storage means.

The method described here has at least the following method steps.

According to method step i), the lithium-containing energy storage means is optionally pretreated, the pretreatment, if carried out, comprising at least one of thermal, mechanical, and electrical pretreatment.

The purpose of pretreatment is in particular to prepare the lithium-containing energy storage means used for the remainder of the method and so for the actual recovery of the raw materials, in particular for the recovery of the lithium, and optionally to start separating some of the raw materials from the lithium-containing product stream. This product stream is also denoted black mass and usually contains at least the active material, preferably cathode active material and anode active material, with the corresponding lithium compound.

Pretreatment can accordingly ensure that subsequent method steps can be carried out more efficiently or more safely. Plastics components or also certain other materials, such as for instance metals, solvents, recyclable WEEE materials (waste electrical and electronic equipment), may for example be removed during pretreatment. For example, cabling, control units, such as for instance the battery management system (BMS) or also components to be referred to as a heavy fraction, such as for instance the module shell or parts thereof, for example made of iron or aluminium, or also contacts, for instance made of copper, can be separated from the lithium-containing product stream that is to be further treated.

Thermal, mechanical, and electrical pretreatment is in particular advantageous as the pretreatment. Pretreatment may be only thermal, only mechanical, or only electrical or involve a plurality of the respective pretreatments carried out in combination simultaneously or one after the other.

In the case of thermal treatment, the energy storage means can in particular be thermally deactivated, such that the following steps can be carried out without any safety concerns. The conductive salt, in particular LiPF₆, is preferably decomposed during thermal pretreatment. The decomposition products of the conductive salt are consequently available for further conversion in the subsequent pyrolysis. Moreover, the organic components or a proportion of low-boiling components, preferably solvents, can be volatilised and then condensed during thermal pretreatment. Electrolyte solvents are preferably volatilised during thermal pretreatment and condensed for recovery. Thermal pretreatment can therefore serve both safety purposes and to begin the separation of the materials of the energy storage means.

Mechanical pretreatment may in particular comprise disassembly of an energy storage means. For example, the energy storage means used can be disassembled down to module or cell level in order to simplify the further method steps and optionally to remove components, such as for instance contacts, shell components and control units from the lithium-containing product stream. It is furthermore possible to mechanically break up, such as for instance shred, the energy storage means, for example under protective gas, while separating the electrolyte.

Electrical pretreatment may in particular comprise preferably complete discharge of the energy storage means. This can be achieved purely electrically by means of a conventional discharge or also by thermal or mechanical treatment. An electrical discharge offers the advantage that the Li ions on the cathode side are intercalated into the transition metal oxides. Since the cathode material is decomposed into short-chain components during pyrolysis, the lithium in the cathode material is more readily accessible after pyrolysis than it would be in the anode material. The yield of lithium can thus be improved.

In line with the above, it may be particularly preferred for the lithium-containing energy storage means to be pretreated according to method step i), method step i) having at least one of the following method steps:
i.1 mechanical disassembly of the lithium-containing energy storage means, preferably down to module or cell level; and
i.2 discharge of the lithium-containing energy storage means; and
i.3 thermal treatment of the energy storage means, the energy storage means preferably being disassembled down to module and/or cell level, preferably to decompose the conductive salt and volatilise solvent, the solvent preferably being condensed for recovery.

In a preferred embodiment, the method comprises thermal pretreatment of the energy storage means disassembled down to module and/or cell level to decompose the conductive salt and volatilise solvent, shredded material being used as the lithium-containing energy storage means in method step ii), the shredded material comprising cathode material and anode material, and the pretreated lithium-containing energy storage means being broken up between the thermal pretreatment and method step ii).

The temperature during thermal pretreatment is preferably no more than 350 °C.

According to method step ii), the method furthermore comprises pyrolysing the optionally pretreated lithium-containing energy storage means, with the liberation of carbon dioxide, and with at least partial carbonation of the contained lithium under a carbon dioxide atmosphere. This step may accordingly comprise thermal treatment of the optionally pretreated energy storage means, thus of the lithium-containing product stream resulting from the pretreatment. Alternatively, the present invention does not rule out the energy storage means to be treated being directly subjected to the thermal treatment or pyrolysis according to method step ii) without pretreatment. Accordingly, not only the product stream from pretreatment, such as for instance shredded material, production scrap, whole cells, or modules, but also the untreated energy storage means can be used for method step ii). It is important for the lithium-containing active material or electrode material, advantageously cathode material, of the energy storage means to be used in order to enable recovery of the lithium. The lithium-containing energy storage means in method step ii) preferably comprises cathode material and anode material. Accordingly, preferably no material is used that contains only minor residues of anode material. For example, the lithium-containing energy storage means in method step ii) preferably contains >20 wt. % anode material, particularly preferably >20 wt. % graphite. The lithium-containing energy storage means in method step ii) furthermore preferably comprises the conductive salt and/or the decomposition products thereof. The lithium-containing energy storage means in method step ii) furthermore preferably contains the current conductors. In other words, cathode material, anode material, conductive salt, and current conductors and the decomposition products thereof are preferably not separated before pyrolysis. Shredded material with adhering cathode and anode active material powder (“powder-coated shredded material”) is preferably used for pyrolysis.

In a preferred embodiment, the temperature during method step ii) (pyrolysis) is 500 °C to 700 °C.

This method step serves in particular to at least partially carbonate the lithium contained in the lithium-containing product stream, i.e. in particular to convert the lithium compounds present in the optionally pretreated battery cells into water-soluble lithium carbonate. This allows the carbonated lithium to be subsequently selectively washed out in aqueous solution, without dissolving further components from the active mass. Another advantage is the possibility of combining leaching with a flotation process to recover the graphite, as is described in greater detail below. Lithium fluoride, which can subsequently be separated, is preferably also formed during pyrolysis. The method is thus preferably also a method for recovering lithium fluoride from lithium-containing energy storage means.

A reducing atmosphere is important for carrying out method step ii) so that carbonation can take place undisturbed. The reducing atmosphere can be established by CO₂ being obtained and so liberated purely by pyrolysis of the lithium-containing material. The active material in principle contains materials, such as for instance NMC and the binder, which also liberate carbon dioxide during pyrolysis in a reducing atmosphere. Accordingly, it may be advantageous in this step for the lithium-containing active material, which has one or more oxygen atoms in its molecular structure, and also the binder to be present as a carbon-containing or organic material, such as PVDF.

In addition to the carbon dioxide obtained, a protective gas, such as for instance argon or nitrogen, can also be supplied to this process step. A suitable atmosphere may present in this way, there being no need for it to be formed solely by carbon dioxide. According to the invention, however, the carbon dioxide obtained is also recirculated, as described in detail below.

It is preferred in the method according to the invention for the carbon dioxide atmosphere, optionally also in combination with protective gas such as argon or nitrogen, to suppress unwanted oxidation reactions. The atmosphere preferably also makes it possible for lithium fluoride to be separated in step iii). Without wishing to be bound to this theory, the inventors assume that the carbon dioxide atmosphere forms a protective gas atmosphere. Pyrolysis under the carbon dioxide atmosphere leads to the decomposition of binders and to the decomposition of long-chain transition metal oxides into simple transition metal oxides, so liberating lithium. This pyrolytic change in the feedstock is manifested, for example, by powder coatings flaking off from the current conductor foils (aluminium and copper foils). During the thermal decomposition of the long-chain transition metal oxides under non-oxidising conditions, the lithium is liberated from the matrix. Since the treatment is carried out on entire modules/cells in which residues of the electrolyte and conductive salt are still present, yield is particularly high.

In a preferred embodiment of the method according to the invention, transition metals such as cobalt, nickel and manganese are not reduced to the metallic transition metal during the pyrolysis method step ii) and in the optional thermal pretreatment.

After pyrolysis, the product stream, i.e. the lithium-containing material that has undergone pyrolysis, is supplied to method step iii). According to method step iii), lithium is separated in a first separating step, separation in particular being taken to mean selective separation of a lithium compound from the residual mass. This may in particular be carried out by leaching the product obtained in the above-described steps. In particular, neutral leaching can take place in an aqueous solution by mixing the product to be treated with water. In this way, the lithium can be highly selectively washed out in the form of lithium carbonate, which has been produced by thermal carbonation as described above, without entraining foreign substances. In this way, lithium carbonate can already be separated in a comparatively clean form and then processed into lithium. In a preferred embodiment, fluoride, in particular lithium fluoride, is also separated in method step iii).

In detail, neutral leaching is carried out for example using only water, which is an advantage over prior art methods that often required the use of acids. Introducing carbon dioxide into the solution is advantageous here, as this gives rise to carbonic acid which can improve the dissolution of lithium compounds in an aqueous solution and thus the discharge of lithium. In a preferred embodiment, the carbon dioxide serves to establish a pH value in the neutral to slightly acidic range, which facilitates the selective separation of lithium.

According to method step iv), the mixture obtained in method step iii), which has been depleted of lithium, is furthermore hydrometallurgically reprocessed. The lithium or lithium compound that is still present is further carbonated in this method step. This step takes place with separation of further substances, in particular metals, such as for instance aluminium, iron, cobalt, nickel and manganese, and thus also of residual lithium. As is known in principle for hydrometallurgical methods, the respective metals can be discharged by a change in pH and/or by extraction with organic solvents.

In the method described here, method step v) furthermore provides that carbon dioxide liberated in method step ii) is returned to at least one of method steps ii) and iii). For example, the carbon dioxide liberated in method step ii) may be returned only to method step ii), only to method step iii), or to both method steps ii) and iii), and it may optionally be directed to further method steps.

When the carbon dioxide obtained is supplied to method step ii), it thus serves to produce a reducing atmosphere and provide a reagent for carbonation.

When the carbon dioxide is supplied to method step iii), it likewise enables supply of a reagent for carbonation as well as improved dissolution of the lithium compound in an aqueous solution by the formation of carbonic acid.

In principle, waste gases from the thermal treatment of lithium-based energy storage means are used for the carbonation of Li compounds and thus at a central point in the recovery of lithium as a new raw material. This results in a CO₂ cycle that is specifically tailored to the process developed here and offers significant synergistic advantages.

For example, in addition to the recirculation of carbon dioxide, it is possible to recirculate other in particular gaseous components, such as for instance protective gases, for example argon or nitrogen, which are for instance obtained in step ii) or fed in there. These may simply be guided together with the carbon dioxide or also be purified and put to purposeful use. This also helps to conserve resources and therefore improves sustainability.

As described above, carbon dioxide is used in method step ii) to carry out carbonation of lithium. It is advantageous to add carbon dioxide to method step ii) for this purpose. The fact that the carbon dioxide obtained is recirculated means that it is possible optionally to dispense with or at least significantly reduce the addition of fresh carbon dioxide. Moreover, it is possible to prevent carbon dioxide arising as a waste gas which, in prior art processes, is usually released into the environment. The method described here may consequently have distinct advantages in environmental terms. The method can moreover be carried out with reduced resources and at lower cost. This in particular results in advantages over prior art solutions. For example, conventional methods for thermally recycling Li-ion batteries generate CO₂ and emit this climate-damaging greenhouse gas into the environment, which runs counter to efforts to reduce CO₂ emissions from industrial processes.

In particular in the case of an additional thermal pretreatment according to method step i), the carbon dioxide is thus obtained in the second thermal treatment step by suitable temperature control of the thermal pretreatment according to method step i) and the pyrolysis according to method step ii). This allows the carbon dioxide obtained to be purposefully generated and used.

The invention thus enables emissions to be reduced by recirculating the CO₂ together with elevated lithium yields without further additives, such as carbonating agents which are necessary in the conventional process. This also saves additional additives, such as pH adjusting agents, for the further hydrometallurgical treatment. The conventional hydrometallurgical process requires a large amount of leaching agents, such as HCl and H₂SO₄, pH adjusting agents, such as NaOH or KOH, or oxidising agents, such as H₂O₂, since the water- and CO₂-based process entails preseparating the lithium and graphite. This results in a mass reduction for the hydrometallurgy, which can be avoided according to the invention.

Purposeful recirculation of CO₂ makes it utilisable and converts it into a product. This offers the advantages of a thermal pretreatment without undesired side effects. Making use of CO₂ generated in the process as a utilisable resource for both lithium and graphite is highly advantageously enabled by an innovative recycling process.

It may furthermore be preferred for the method to comprise the further method step of flotation, for example before method step iv). A preferred embodiment of the method comprises flotation for obtaining the anode material. Flotation preferably takes place after method step iii) and before method step iv). In one embodiment, method step v) takes place in such a way that at least some of the returned carbon dioxide is used in the flotation. Flotation should be taken in per se known manner to mean a physicochemical separation method for fine-grained solids based on the differing surface wettability of the particles. The method takes place in a liquid, such as in particular water, and furthermore with the supply of gas, such as for instance air. Anode material, in particular graphite, can particularly preferably be removed from the product stream in the development described here. Graphite is usually present in energy storage means as an anode material and is furthermore a valuable raw material classified as critical by the EU. In the method according to the invention, the anode material preferably comprises graphite.

Very small quantities of additives are optionally also added to the aqueous solution to influence attrition in such a way that graphite particles float to the surface as foam and metallic particles sink. The foam can then be skimmed off and the graphite separated in this way.

Separating the graphite offers a further significant advantage over prior art methods in which CO₂ is generated by combusting graphite and converting it into CO₂/CO. In contrast, the invention can prevent the loss of a critical raw material combined with additional generation of CO₂. The graphite is inert in preferred embodiments of the method according to the invention.

According to this development, the flotation method may particularly preferably be carried out using carbon dioxide as carbon dioxide is generated in situ in the method, does not interfere with the, and is furthermore advantageously suitable for bubble formation or foaming.

It may furthermore be preferred for the carbon dioxide returned in method step v) to be purified before being returned, in particular in at least one method step of method steps ii) and/or iii) and/or during flotation. Foreign substances present in the gas stream can thus in particular be removed. This can be achieved, for example, by a filter unit which makes it possible to remove entrained solids from the gas stream. It is additionally or alternatively also possible to remove gaseous impurities from the gas stream by using per se known gas separation methods.

This step allows method step ii) to be carried out particularly efficiently since no foreign substances or waste materials or, in principle, impurities are reintroduced into the product stream to be treated. The product leaving method step ii) can therefore be improved with regard to the provision of unwanted foreign substances, so enabling improved purification of the lithium obtained.

It may furthermore be preferred for carbon dioxide to be supplied at least intermittently as fresh gas to method step ii). This development can take account of the fact that the returned carbon dioxide may not be sufficient to form the atmosphere in method step ii). New or non-returned carbon dioxide can accordingly be supplied to method step ii). Adding fresh gas may in particular be advantageous when starting up the process.

The origin of the fresh CO₂ gas not in principle restricted. However, it is advantageous, for example, for the CO₂ to originate from a “CC” process, which may also be known as a carbon capture process and describes the capture of carbon dioxide, in particular from waste gases from combustion, and its subsequent use in further chemical processes. This development can further improve environmental aspects and thus the sustainability of the method described here.

It may furthermore be preferred for method step ii) to be carried out in a continuously operated moving-bed reactor. It has been found that in particular in this development, effective carbonation of the lithium species can be enabled by circulating the material.

This may enable effective leaching of the lithium carbonate in subsequent steps and thus particularly effective and clean recovery of the lithium.

However, the method is not in principle restricted to a continuously operated moving-bed reactor. For the purposes of the present invention, batch methods possible or also other reactors are also possible for carrying out the pyrolysis according to method step ii).

It may further be preferred for method step ii) to be carried out at temperatures in a range from greater than or equal to 300 °C to less than or equal to 800 °C. Method step ii) may preferably be carried out at temperatures in a range from greater than or equal to 350 °C to less than or equal to 560 °C, for instance of greater than or equal to 400 °C to less than or equal to 560 °C. In particular in this temperature range, the process step can be carried out in an energy-saving manner. It can, however, furthermore be ensured that effective thermal carbonation takes place, such that it can be ensured that a large quantity of lithium compounds are already carbonated and react to yield lithium carbonate.

In particular in this development but not limited thereto, it is possible to enable the waste gas stream, thus in particular the discharged and returned carbon dioxide stream, to have a high temperature, which is likewise utilisable in the method described here. The waste heat from the carbon dioxide stream leaving the pyrolysis can in principle be used for adjusting the temperature of further processes, such as for leaching the lithium carbonate or also for hydrometallurgical methods. The hot carbon dioxide may to this end accordingly pass through a heat exchanger or also be directly introduced into a process.

Purely by way of example, the waste gas can be recirculated into the thermal pretreatment for establishing a suitable process atmosphere for purposeful phase transformation within the cathode material, which is particularly advantageous for subsequent treatments.

It may furthermore be preferred for the product obtained in method step ii) to be mechanically processed between method steps ii) and iii). This processing step may in particular serve to further concentrate the lithium-containing material in order to further improve the processing of the lithium. In detail, this processing step serves, for example, to separate aluminium and copper foils as well as shell parts, insofar as they are still present, from the active mass. This may take place, for example, by vigorous screening or impact milling. As a person skilled in the art will understand, this method step may be carried out as a function of the substances actually still present or the quantity thereof.

Preferably, no solid carbon is added in the method for thermal pretreatment and/or pyrolysis. In particular, preferably no coal, activated carbon, anthracite or the like is added for thermal pretreatment and/or pyrolysis.

In the light of the above, the present invention furthermore provides use of a method as described above for reprocessing a lithium-containing energy storage means. In particular, the present invention provides use of a method as described above for recovering lithium and/or anode material from lithium-containing energy storage means. In other words, the method according to the invention is preferably a method for recovering lithium and/or anode material from lithium-containing energy storage means.

As described above, purposeful recirculation in the defined used allows the CO₂ obtained to be utilisable and converted into a product. This offers the advantages of a thermal pretreatment without undesired side effects. Making use of CO₂ generated in the process as a utilisable resource for both lithium and graphite is highly advantageously enabled by an innovative recycling process. In comparison with prior art solutions, good environmental performance is combined with comparatively low costs and a possible elevated purity of the recovered lithium. The process is thus cost-effective and environmentally enhanced and enables economically viable recovery of lithium and graphite.

The invention is explained below by way of example with reference to the appended drawings, with the features shown below each possibly individually or in combination being an aspect of the invention, and the invention not being limited to the following drawings, the following description and the following exemplary embodiments.

### BRIEF DESCRIPTION OF THE DRAWINGS

In the drawings:

FIG. 1 shows a schematic flow chart of an exemplary development of a method according to the present invention.

### DETAILED DESCRIPTION

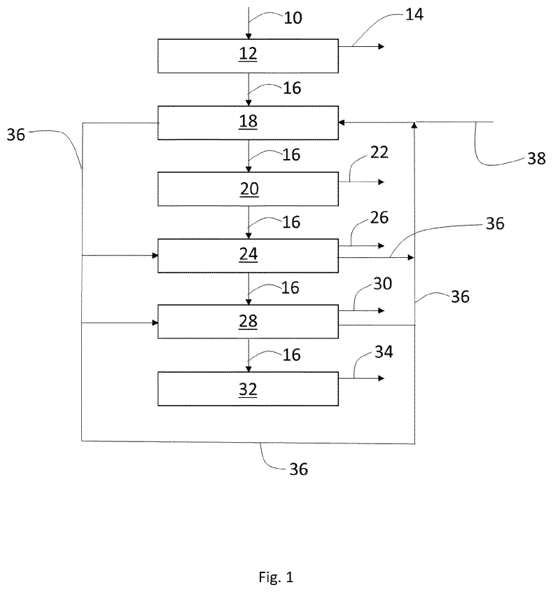

FIG. 1 is a schematic flow chart of a method of the present invention. Such a method is used to reprocess lithium-containing energy storage means and, in so doing, recover raw materials, in particular lithium, incorporated therein.

The chart shows the introduction 10 of the lithium-containing energy storage means into the method.

The lithium-containing energy storage means is firstly optionally pretreated 12. This pretreatment 12 may be, for example, thermal, mechanical and/or electrical and in particular serve to discharge or deactivate the energy storage means. Components of the energy storage means may furthermore be expelled 14. Expulsion 14 makes it possible, for example, to remove plastics components, metal components or also electrical components, without being limited thereto, and thus separate them from the lithium-containing product stream 16 which is to be further treated. The pretreatment 12 accordingly preferably comprises at least one of the following method steps:
i.1 mechanical disassembly of the lithium-containing energy storage means;
i.2 discharge of the lithium-containing energy storage means; and
i.3 thermal treatment of the energy storage means.

The forwarded product stream 16 or the optionally pretreated energy storage means is furthermore subjected to preferably continuously operated pyrolysis 18, for instance at temperatures in a range from 300 °C to 800 °C and/or in a moving-bed reactor. Pyrolysis 18 takes place under a carbon dioxide atmosphere and thus under reducing conditions, and with at least partial carbonation of the contained lithium. Materials contained in the product stream, such as in particular active material and binder components, furthermore decompose such that carbon dioxide is obtained or liberated during pyrolysis 18.

The product obtained during pyrolysis 18 is optionally mechanically treated 20. This processing step may in particular serve to further concentrate the lithium-containing product stream 16 in order to further improve the processing of the lithium. In detail, this processing step serves, for example, to separate aluminium and copper foils and shell parts, insofar as they are still present, by expulsion 22 from the active mass or from the lithium-containing product stream 16.

Lithium is subsequently separated 24 by separation in a separating step. This may in particular be carried out by leaching the product obtained in the above-described steps. In particular, neutral leaching can take place in an aqueous solution by mixing the product to be treated with water. As a result, an aqueous solution with lithium in the form of lithium carbonate, which has formed as a water-soluble product during pyrolysis, can be expelled 26.

In order to remove graphite from the lithium-containing product stream 16, this stream is then subjected to a flotation process 28. A gas, such as in particular carbon dioxide, can be introduced into a flotation tank or liquid contained therein together with the lithium-containing product stream 16, whereby the graphite can be separated and be removed from the lithium-containing product stream 16 by expulsion 30.

The lithium-containing product stream 16 is finally hydrometallurgically reprocessed 32, in particular with further carbonation of the contained lithium and with separation of lithium in a further separating step by expulsion 34. In addition to lithium, further components, in particular metals, can be expelled by pH-alternation methods and/or by extraction processes.

FIG. 1 furthermore shows that carbon dioxide liberated during the pyrolysis 18 is recirculated 36 in a cycle and supplied to at least one of the method steps of pyrolysis 18 and separation 24. The carbon dioxide may furthermore be supplied to the flotation process 28. It may in principle be preferred for the returned, i.e. supplied, carbon dioxide to be purified before being returned/supplied.

Recirculation 36 may in itself be sufficient to create a suitable atmosphere during pyrolysis 18. It may, however, become necessary for carbon dioxide to be supplied 38 at least intermittently to the pyrolysis 18 as fresh gas. Protective gas can additionally or alternatively be supplied to the pyrolysis 18, this gas possibly likewise being recirculated and optionally purified.

A further example describes a method which is likewise a method for recovering lithium and anode material from lithium-containing energy storage means, the anode material comprising graphite.

Production scrap, cells, modules and optionally also shredded material may be used as lithium-containing energy storage means, production scrap and modules being disassembled down to cell level in this example.

The lithium-containing energy storage means is firstly pretreated 12. This pretreatment 12 comprises thermal pretreatment of the energy storage means disassembled down to cell level at no more than 350 °C to decompose the conductive salt and volatilise solvent, the solvent being condensed for recovery, and breaking up the thermally pretreated lithium-containing energy storage means, such that shredded material is used as the lithium-containing energy storage means in the subsequent pyrolysis.

Components of the energy storage means are furthermore expelled 14. Expulsion 14 makes it possible, for example, to remove plastics components, metal components or also electrical components and thus separate them from the lithium-containing product stream 16 which is to be further treated.

The forwarded product stream 16 or the pretreated energy storage means is then subjected to continuously operated pyrolysis 18, for instance at temperatures in a range from 500 °C to 800 °C in a moving-bed reactor. Anode and cathode material is not separated before pyrolysis, such that the forwarded product stream 16 or pretreated energy storage means contains cathode material and anode material during pyrolysis. Pyrolysis 18 takes place under a carbon dioxide atmosphere, which suppresses oxidation reactions and contains a protective gas selected from argon and nitrogen, and with at least partial carbonation of the contained lithium. Materials contained in the product stream, such as in particular active material and binder components, furthermore decompose such that carbon dioxide is obtained or liberated during pyrolysis 18.

The product obtained during pyrolysis 18 is then mechanically treated 20. This processing step in particular serves to further concentrate the lithium-containing product stream 16 in order to further improve the processing of the lithium. In detail, this processing step serves, for example, to separate aluminium and copper foils and shell parts, insofar as they are still present, by expulsion 22 from the active mass or from the lithium-containing product stream 16.

Lithium is subsequently separated 24 by separation in a separating step. This is carried out by leaching the product obtained in the above-described steps. In particular, neutral leaching takes place in an aqueous solution by mixing the product to be treated with water. As a result, an aqueous solution with lithium in the form of lithium fluoride and lithium carbonate, which has formed as a water-soluble product during pyrolysis, can be expelled (expulsion 26).

In order to remove and obtain the graphite anode material from the lithium-containing product stream 16, this stream is then subjected to a flotation process 28. Carbon dioxide is introduced into a flotation tank or liquid contained therein together with the lithium-containing product stream 16, whereby the graphite can be separated and be removed from the lithium-containing product stream 16 by expulsion 30.

The lithium-containing product stream 16 is finally hydrometallurgically reprocessed 32, with further carbonation of the contained lithium and with separation of lithium in a further separating step by expulsion 34. In addition to lithium, further components, in particular metals, can be expelled by pH-alternation methods and/or by extraction processes.

As shown in the first example and in FIG. 1, carbon dioxide liberated during pyrolysis 18 can optionally be recirculated 36 in a cycle and supplied to at least one of the method steps of pyrolysis 18, separation 24, and to the flotation process 28. The returned, i.e. supplied, carbon dioxide may be purified before being returned, i.e. supplied.

### REFERENCE SIGNS

10 Introduction
12 Pretreatment
14 Expulsion
16 Lithium-containing product stream
18 Pyrolysis
20 Mechanical treatment
22 Expulsion
24 Separation
26 Expulsion
28 Flotation process
30 Expulsion
32 Hydrometallurgical reprocessing
34 Expulsion
36 Recirculation
38 Supply

1. A method for reprocessing lithium-containing energy storage means, the method comprising at least the following method steps:
i) optionally pretreating the lithium-containing energy storage means, the pretreatment comprising at least one of thermal, mechanical, and electrical pretreatment;
ii) pyrolysing the optionally pretreated lithium-containing energy storage means, with the liberation of carbon dioxide, and with at least partial carbonation of the contained lithium under a carbon dioxide atmosphere;
iii) separating lithium in a separating step; and
iv) hydrometallurgically reprocessing the mixture obtained in method step iii), with further carbonation of the contained lithium and with separation of lithium in a further separating step, with
v) carbon dioxide liberated in method step ii) being returned to at least one of method steps ii) and iii).

2. A method for reprocessing lithium-containing energy storage means, the method comprising at least the following method steps:
i) optionally pretreating the lithium-containing energy storage means, the pretreatment comprising at least one of thermal, mechanical, and electrical pretreatment;
ii) pyrolysing the optionally pretreated lithium-containing energy storage means, with the liberation of carbon dioxide, and with at least partial carbonation of the contained lithium under a carbon dioxide atmosphere;
iii) separating lithium in a separating step; and
iv) hydrometallurgically reprocessing the mixture obtained in method step iii), with further carbonation of the contained lithium and with separation of lithium in a further separating step.

3. The method according to claim 1, wherein step v) takes place in such a way that at least some of the returned carbon dioxide is used in method step iii).

4. The method according to claim 1, further comprising a step of flotation after method step iii) and before method step iv), method step v) optionally taking place in such a way that at least some of the returned carbon dioxide is used in the flotation.

5. The method according to claim 1, wherein the carbon dioxide returned in method step v) is purified before being returned.

6. The method according to claim 1, wherein the lithium-containing energy storage means in method step ii) comprises cathode material and anode material.

7. The method according to claim 1, wherein the lithium-containing energy storage means is pretreated according to method step i), method step i) having at least one of the following method steps:
i.1 mechanical disassembly of the lithium-containing energy storage means down to module or cell level;
i.2 discharge of the lithium-containing energy storage means; and
i.3 thermal treatment of the energy storage means disassembled down to module and/or cell level to decompose the conductive salt and volatilize-volatilizing solvent, the solvent preferably being condensed for recovery.

8. The method according to claim 1, wherein method step ii) is carried out in a continuously operated moving-bed reactor.

9. The method according to claim 1, wherein material selected from shredded material, production scrap, cells, modules and mixtures thereof, is used as the lithium-containing energy storage means.

10. The method according to claim 6, wherein the method comprises flotation for obtaining the anode material, flotation preferably taking place after method step iii) and before method step iv).

11. The method according to claim 1, wherein the method is a method for recovering lithium and anode material from lithium-containing energy storage means.

12. The method according to claim 11, wherein the anode material comprises graphite.

13. The method according to claim 1, wherein the method is a method for recovering lithium fluoride and lithium fluoride is separated in method step iii).

14. The method according to claim 1, wherein the carbon dioxide atmosphere suppresses oxidation reactions and preferably contains a protective gas selected from argon and nitrogen.

15. The method according to claim 1, wherein the method comprises thermal pretreatment of the energy storage means disassembled down to module and/or cell level to decompose the conductive salt and volatilize solvent, and shredded material is used as the lithium-containing energy storage means in method step ii), the shredded material comprising cathode material and anode material, and the pretreated lithium-containing energy storage means being broken up between the thermal pretreatment and method step ii).
